(19) United States
(12) Patent Application Publication
(10) Pub. No.: US 2018/0304652 A1
(43) Pub. Date: Oct. 25, 2018

(54) Control Assembly

(71) Applicant: Dover Europe Sarl, Vernier (CH)

(72) Inventors: Florian Tenaud, Nottingham (GB); Nicky Bond, Nottingham (GB)

(21) Appl. No.: 15/959,950

(22) Filed: Apr. 23, 2018

Related U.S. Application Data
(62) Division of application No. 15/418,202, filed on Jan. 27, 2017.

(30) Foreign Application Priority Data
Jan. 27, 2016 (GB) 1601535.6

(51) Int. Cl. B41J 25/00; B41J 25/312; B41J 2/325; B41J 25/304

(52) U.S. Cl. CPC B41J 25/001; B41J 25/312; B41J 25/304; B41J 2/325

(57) ABSTRACT

A control assembly includes: a drive-belt assembly including a first motor which is operable to rotate a first spindle, and a second spindle, the first and second spindles defining at least a portion of a belt path, and a drive-belt engaged with and extending between the first and second spindles, the first motor being operable to cause movement of the drive-belt; and a printhead movement assembly, which includes a first movement assembly on which a printhead is supportable and allows movement of the printhead along a first axis, and a second movement assembly which extends along a second axis and is configured to support the first movement assembly, the second movement assembly permitting movement of the first movement assembly and the printhead along the second axis; wherein operation of the motor causes the printhead to move along at least one of the first and second axes.

### CROSS-REFERENCE TO RELATED APPLICATIONS

This application is a divisional application of and claims priority to U.S. application Ser. No. 15/418,202, filed on Jan. 27, 2017, which claims the benefit of priority under 35 U.S.C. § 119 of UK Patent Application No. 1601535.6, filed Jan. 27, 2016.

### BACKGROUND

This invention relates to a control assembly for moving a printhead of a printing apparatus.

A thermal transfer printer typically uses inked ribbon (also known as a tape) which extends between two spools. A printhead moves to press the ribbon against a substrate and heating elements are selectively activated on the printhead to melt the ink on the ribbon and transfer the ink to the substrate. The two spools rotate to transfer the inked ribbon, in order to repeatedly present new portions of ribbon to the printhead, for melting onto the substrate.

It is known to operate a transfer printing apparatus in two different configurations. In “intermittent” printing, the substrate and the ribbon are held stationary during a printing operation, whilst the printhead is moved relative to the substrate and the ribbon. At the start of the printing operation the printhead presses the ribbon against the substrate. The printhead typically presses the ribbon and substrate against a flat platen and then the printhead is moved relative to the substrate, ribbon and platen to print onto the substrate. Once the printing operation is complete, the printhead is lifted away from the platen (and the substrate and ribbon). The ribbon and/or the substrate is advanced to present a fresh portion of ribbon and/or substrate for the next printing operation.

In “continuous” printing, the substrate is advanced past the printhead substantially continuously. The ribbon is accelerated to match the speed of the substrate before the printhead presses the ribbon against the substrate. Typically, the platen in this configuration is a cylindrical roller. The printhead is generally maintained in a stationary position during each printing operation.

Often, the printhead is required to move in two axes. Typically, the printhead must move in a substantially lateral direction relative to the ribbon and/or platen and/or substrate such that the printhead can be positioned in the correct location over the ribbon and substrate (and platen). The printhead must also be able to move in a substantially vertical direction (i.e. towards and away from the ribbon, substrate and platen), such that the printhead can press the ribbon against the substrate and melt the ink onto the substrate.

Known systems are typically complicated and require many additional components/systems in order to achieve the desired movement of the printhead. For example, WO2013/025749 describes a pair of belts to move the printhead along two axes. WO2012/05275641 describes a mechanical coupling between a stepper motor in one plane combined with a belt drive for movement of the printhead in a second plane.

### SUMMARY

Embodiments of the current invention aim to ameliorate one or more of the problems associated with the prior art.

According to a first aspect of the present invention, there is provided a control assembly for moving a printhead of a printing apparatus, the control assembly including; a drive-belt assembly including a first spindle, a second spindle, the first and second spindles defining at least a portion of a belt path, a first motor which is operable to rotate at least one of the first spindle and the second spindle and a drive-belt in driving engagement with and extending between the first and second spindles; the first motor being operable to cause movement of the drive-belt, the control assembly further including a printhead movement assembly, which includes a first movement assembly on which a printhead is supportable and allows movement of the printhead along a first axis, and a second movement assembly which is configured to support the first movement assembly, the second movement assembly permitting movement of the first movement assembly and the printhead along a second axis; wherein at least a part of the printhead movement assembly is connectable to the drive-belt assembly such that an operation of the first motor causes the printhead to move relative to at least a part of the first movement assembly along the first axis and the or an operation of the first motor causes the printhead to move relative to at least part of the second movement assembly along the second axis.

The drive belt assembly may include a second motor which may be operable to rotate the other of the first and second spindles.

The first and second axes may be substantially orthogonal to one another.

The printhead movement assembly may include a biasing member configured to oppose the movement of the printhead along one of the first and second axes, in at least one direction. The biasing member may be a coil spring.

The first movement assembly may include a pair of drive-belt guides which may further define the belt path. Optionally, the drive-belt guides may be positioned on the first movement assembly and each drive-belt guide is located between the printhead and a respective one of the first and second spindles.

The drive-belt assembly may further include third and fourth rotatable spindles which may further define the belt path. Optionally, the first movement assembly may include four drive-belt guides which further define the belt path.

The belt path which approaches each belt guide may be generally perpendicular with the belt path which leaves the respective belt guide.

The drive-belt may form a continuous loop.

The drive-belt may include at least two portions which are paired with one another, wherein during movement of the printhead, one of the paired portions extends and the other paired portion shortens by a substantially equal amount. The drive-belt may include at least two paired portions, wherein during movement of the printhead, the movement of the two paired portions is mirrored, such that at least two corresponding portions of drive-belt extend whilst at least two corresponding portions of drive belt shorten by a substantially equal amount.

The control assembly may be for a printing apparatus of the type which uses a printhead to transfer ink from a ribbon on to a substrate.

According to a second aspect of the invention, a method of operating a control assembly according to the first aspect of the invention is provided. The method may include bringing a printhead of a printing apparatus into proximity with a substrate on which printing will occur, wherein the printing apparatus includes a control assembly comprising a drive-belt assembly and a printhead movement assembly, and operating at least one motor to rotate a first spindle, a second spindle, or both the first and second spindles of the drive-belt assembly to cause movement of a drive-belt, which is engaged with the first and second spindles, and which is coupled with at least a part of the printhead movement assembly, wherein the movement of the drive-belt causes movement of the printhead along a first axis and a second axis.

The method may include rotating the first and second spindles in the same rotational directions to each other at substantially the same rotational velocities.

The method may include rotating the first spindle in a direction and holding the second spindle substantially stationary (e.g. within the tolerances of the motor(s) and mechanical structures used).

The method may include rotating the first and second spindles in opposite rotational directions to each other at substantially the same rotational velocities.

The method may include rotating the first and second spindles in the same or opposite rotational directions to each other at different rotational velocities.

According to a third aspect of the invention, there is provided a printing apparatus including a control assembly according to the first aspect of the invention. The printing apparatus may be a thermal transfer printer.

According to a fourth aspect of the present invention, there is provided a control assembly for moving a printhead of a printing apparatus, the control assembly including: a drive-belt assembly including a first spindle, a second spindle, the first and second spindles defining at least a portion of a belt path, a first motor which is operable to rotate at least one of the first spindle and the second spindle and a drive-belt in driving engagement with and extending between the first and second spindles; the first motor being operable to cause movement of the drive-belt, the control assembly further including a printhead movement assembly, which includes a first movement assembly on which a printhead is supportable and allows movement of the printhead along a first axis, and a second movement assembly which is configured to support the first movement assembly, the second movement assembly permitting movement of the first movement assembly and the printhead along a second axis; wherein at least a part of the printhead movement assembly is connectable to the drive-belt assembly such that rotation of the motor causes the printhead to move relative to at least a part of at least one of the first and second movement assemblies, along at least one of the first and second axes.

According to a fifth aspect of the invention, there is provided a method of operating a control assembly according to the fourth aspect of the invention, the method including: operating the first motor such that the first spindle rotates in a direction which enables the printhead and first movement assembly to move along at least a part of the second movement assembly along the second axis.

The control assembly may further include a second motor which is operable to rotate the other of the first and second spindles the method including: operating the first and second motors such that the first and second spindles rotate in the same direction and the printhead and at least a part of the first movement assembly move along a part of the second movement assembly, along the second axis.

The length of the drive-belt in the drive-belt path may be maintained substantially constant during operation.

According to a sixth aspect of the invention, there is provided a method of operating a control assembly according to the fourth aspect of the invention the method including: operating the first motor in a direction such that the first spindle rotates and the second spindle is held substantially stationary such that the printhead moves along at least a part of the first movement assembly, along the first axis.

Where the control assembly includes two motors, the method may include: operating the first and second motors such that the first and second spindles rotate in opposite directions such that the printhead moves along at least a part of the first movement assembly, along the first axis.

The method may include varying the length of the drive-belt extending between the spindles and/or extending between one or more spindles and one or more respective guide members in the belt path using rotation of the first and second spindles.

An amount of drive-belt fed into the belt path between the spindles may be substantially the same as the amount of drive-belt taken out of the belt path.

### BRIEF DESCRIPTION OF THE DRAWINGS

Embodiments of the invention will now be described, by way of example only, with reference to the accompanying drawings in which:

FIG. 1 shows a front view of a control assembly according to a first embodiment of the present invention;

FIG. 2 shows a perspective view of the control assembly of FIG. 1;

FIG. 3 shows a side view of a control assembly according to a second embodiment of the present invention;

FIG. 4 shows a perspective view the control assembly of FIG. 3;

FIG. 5 shows a further perspective view of the control assembly of FIGS. 3 and 4;

FIG. 6 illustrates movement of the control assembly of FIGS. 3 to 5; and

FIG. 7 illustrates movement of the control assembly of FIGS. 3 to 6.

### DETAILED DESCRIPTION

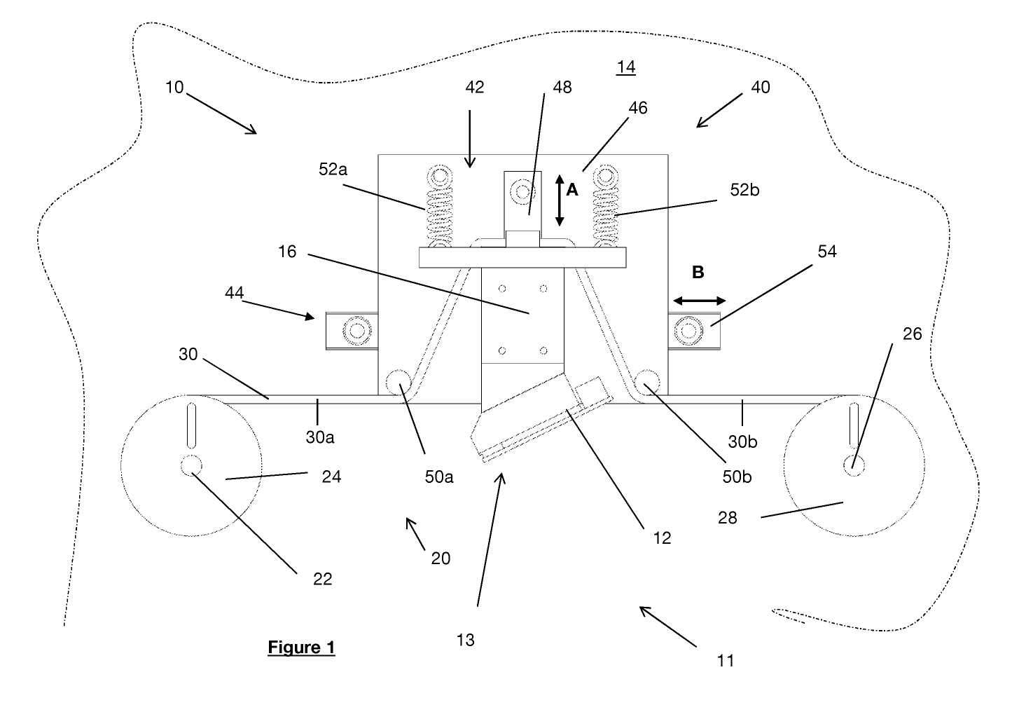

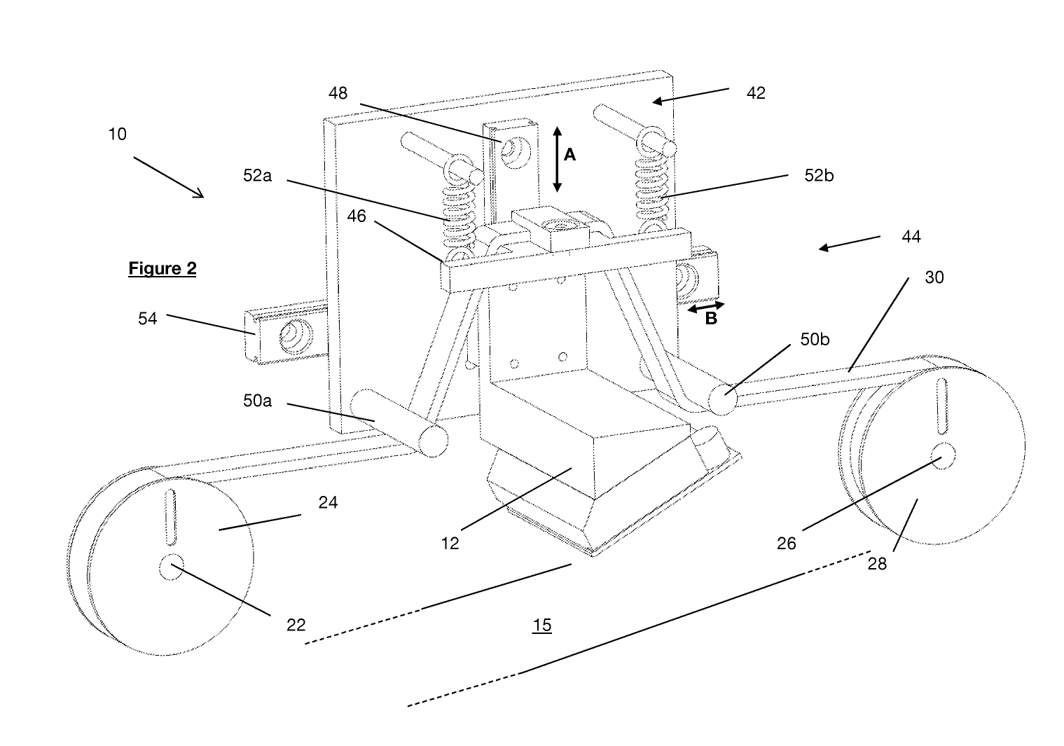

With reference to FIGS. 1 and 2, a control assembly 10 for moving a printhead 12 of a printing apparatus 11 is shown. The control assembly 10 includes a drive belt assembly 20 and a printhead movement assembly 40. The drive belt assembly 20 is connected to the printhead movement assembly 40, so that the control assembly 10 is operable to control the movement of the printhead 12 of the printing apparatus 11.

The printing apparatus 11 is of the type which uses an inked ribbon extending between a motor driven supply spool and take-up spool (e.g. a thermal transfer overprinter). The printhead 12 is moveable towards and away from a substrate 15 (i.e. the printhead 12 moves substantially reciprocally) to sandwich the inked ribbon between the printhead 12 and the substrate 15. Heating elements 13 on the printhead 12 are heated to a desired temperature to melt the ink from the ribbon onto the substrate 15, so a desired image/text can be printed.

In a “normal” orientation the tape drive is oriented such that during a printing operation the printhead 12 moves in a substantially vertical, substantially upward and downward direction towards and away from the inked ribbon and substrate 15. The components of the control assembly 10 which are discussed herein are described relative to this “normal” orientation. However, it should be appreciated that the tape drive, and hence the control assembly 10 can be mounted and operate in many different orientations whilst still performing in the manner described.

The drive-belt assembly 20 and the printhead movement assembly 40 are mounted on a backing plate 14, which is integrated with the tape drive 11.

In some embodiments the drive-belt assembly 20 has a first motor 22 which is operable to rotate a first spindle 24. In some embodiments the drive-belt assembly 20 may also have a second motor 26 which is operable to rotate a second spindle 28. The first and second spindles 24, 28 are rotatably mounted on the backing plate 14. The first and second spindles 24, 28 are spaced apart generally horizontally (when the control assembly 10 is in “normal” operating orientation). The first and second spindles 24, 28 are also positioned at generally the same height on the backing plate 14. However, it should be appreciated that there are many positions in which the spindles 24, 28 can be located while still being able to operate in the manner described herein.

In some embodiments, the first and second spindles 24,28 may be driven by the same motor. In such embodiments, a clutch mechanism and/or gearing mechanism and/or other control may be used to allow the spindles 24, 28 to rotate independently of each other. This means that a single motor is able to control the spindles 24,28 so that they can rotate in the same or different directions to each other and/or at the same or different speeds to each other.

A drive-belt 30 is connected at or towards each of its ends to one of the first and second spindles 24, 28 (in driving engagement with the spindles 24, 28) and extends between them. In other words, one end of the drive-belt 30 is connected to the first spindle 24 and the other end of the drive-belt 30 is connected to the second spindle 28. The path through which the drive-belt 30 extends is defined as a belt path, and the spindles 24, 28 define at least a part of the belt path. Further details of the drive-belt 30 are discussed below.

The printhead movement assembly 40 includes a first movement assembly 42 and a second movement assembly 44. The first movement assembly 42 enables the printhead 12 to move in a first direction and a second direction along a first axis indicated by double-headed arrow A. In this embodiment, the first axis “A” extends substantially vertically, so the first movement assembly 42 permits movement of the printhead 12 in the first (e.g. upward) and second (e.g. downward) direction, but it should be appreciated that this is not always necessarily the case.

The first movement assembly 42 includes a plate 46, a first track portion 48, and two belt guides 50a, 50b to guide the drive-belt 30 of the drive belt assembly 20. In some embodiments, the first movement assembly 42 also includes two biasing members 52a, 52b. The plate 46 is substantially planar and generally square/rectangular in shape. It will be appreciated that other configurations and/or shapes may be used, as appropriate.

The first track portion 48 is attached to the plate 46 and extends generally in the first and second direction, which in the present embodiment means that the first track portion 48 is oriented substantially vertically (although this need not always be the case).

In the embodiment shown in FIG. 1, the printhead 12 is supported by the first movement assembly 42. The printhead 12 is mounted on the first track portion 48, which permits the printhead 12 to move in the first and second directions relative to the plate 46. In this example, the printhead 12 is moveable substantially reciprocally along the first track portion 48 in the first (e.g. upward) and second (e.g. downward) directions (e.g. along the axis A). In the example shown, the printhead 12 is engageable with the first track portion 48, and is moveable along the first track portion 48 in the first and second directions. In the present example, the printhead 12 includes a connection part 16 which is engageable with the first track portion 48.

The connection part 16 is engageable with the drive-belt 30 and the connection part 16 further defines the belt path. Preferably the drive belt 30 is secured to the connection part 16. It should be appreciated that in this example the connection part 16 may be integral with the printhead 12, for example it may be a protrusion which extends from a surface of the printhead 12, but the drive-belt 30 can be attached directly to (and/or be engageable with) the printhead 12 or to an alternative part of the printhead movement assembly 40 to or with which the printhead 12 engages and/or to which the printhead 12 is connectable.

The drive-belt 30 includes a first portion 30a which extends between the connection part 16 and the spindle 24 and a second portion 30b which extends between the connection part 16 and the spindle 28. The two portions 30a, 30b of the drive-belt 30 are considered to be paired with one another.

The two biasing members 52a, 52b (in this example, coil springs) are positioned on either side of the first track portion 48 (e.g. one spring on each side). Each biasing member 52a, 52b is attached, at or near one of its ends, to the plate 46 and, at an opposing end, to a part of the printhead 12 (either directly or indirectly, for example via the connection part, or even to an additional part which is attached to the connection part 16). The biasing members 52a, 52b are biased to oppose downward movement of the printhead 12 relative to the first track portion 48. For example, the biasing members 52a, 52b extend in length as the printhead 12 is driven in the second direction, e.g. downwards, along axis A (i.e. towards the inked ribbon and substrate). When the printhead 12 is required to move in the first direction, (i.e. upwards, away from the inked ribbon and the substrate) the biasing members 52a, 52b shorten in length (i.e. they exert a force upwards, towards their neutral positions) and the printhead 12 moves along the track portion 48 in the first, i.e. upward direction. It should be appreciated that the biasing members 52a, 52b can be placed to oppose movement of the printhead 12 in another direction. It should also be appreciated that two biasing members 52a, 52b may not be required, for example one biasing member can be provided, or more than two. The biasing member or members should be arranged so their combined force acts through the centre of the first track portion 48.

The two belt guides 50a, 50b (in this example, two substantially cylindrical rollers) are mounted on the plate 46, each adjacent the lower-most corners of the plate 46.

The belt guides 50a, 50b further define the belt path, and the drive-belt 30 is disposed around each of the belt guides 50a, 50b.

The plate 46 of the first movement assembly 42 is mounted on the second movement assembly 44 such that at least parts of the first movement assembly 42 (and the printhead 12) are configured to move relative to the second movement assembly 44.

The second movement assembly 44 includes a second track portion 54 which extends along a second axis B (in this embodiment, the second axis B extends substantially horizontally and generally transverse, and more preferably orthogonal, to the first axis A). The second track portion 54 is attached to the backing plate 14. The second movement assembly 44 permits the first movement assembly 42 to move along the second axis indicated by double-headed arrow B. Since the printhead 12 is supported on the first movement assembly 42, the second movement assembly 48 permits the printhead 12 to move along the second axis B, in a third (e.g. left) and a fourth (e.g. right) direction.

The plate 46 of the first movement assembly 42 is mounted to the second track portion 54 such that the plate 46, and therefore the parts of the first movement assembly which are positioned on or supported by the plate 46, are moveable along the second axis B. Thus, the printhead 12 (which is engageable with the first track portion 48 which is mounted on the plate 46) is moveable relative to the second track member 54 in the second and third directions, (e.g. left and right when in ‘normal’ orientation).

In some embodiments, in use, the first motor 22 and in some embodiments, the second motor 26 is operable to rotate the spindles 24, 28 which, in turn, cause movement of the drive-belt 30 in the belt path. The drive-belt 30 is connected to or engaged with the connection part 16 of the printhead 12, and hence when the drive-belt 30 moves, the printhead 12 also moves. The printhead 12 is moveable relative to at least one of the first and second track portions 48, 54 along the first and/or second axes A, B. As the printhead 12 moves along the second axis B, one of the portions 30a, 30b of drive-belt 30 (as defined above) shortens, and the other portion 30a, 30b of the pair of drive-belt portions 30a, 30b lengthens by substantially the same amount. A substantially equal and opposite change in length occurs (i.e. in accordance with the properties of the belt material and the mechanical structures used) to each portion 30a, 30b of the pair of drive-belt portions 30a, 30b during movement of the printhead 12.

More particularly, when the first motor 22, or the first and second motors 22, 26 drive the spindles 24, 28 in the same rotational direction as one another, at substantially the same rotational velocity (and the spindles 24, 28 are the same diameter), the length of drive-belt 30 in the belt path remains substantially constant (i.e. the length of the drive-belt between a point on the first spindle 24 and a corresponding point on the second spindle 28 remains constant—the point may be a point on the perimeter of the respective spindle which is intersected by a vertical line drawn through the spindle's central point (i.e. a top dead centre position, for example). For example, when both the first motor 22, or the first motor 22 and the second motor 26 rotate the spindles 24, 28 in a clockwise direction (at substantially the same rotational velocity), at least a portion of the drive-belt 30 will be unwound from the first spindle 24 and a substantially equal portion, to the portion unwound from the first spindle 24, of the drive-belt 30 is wound onto the second spindle 28 (at substantially the same rate). This movement will result in the printhead 12 moving in the fourth direction, e.g., substantially horizontally right, because the plate 46 to which the printhead is indirectly attached will be caused to move along the second track portion 55, along the axis B. In this example, the first portion 30a of the drive belt 30 extends, and the second portion 30b of the drive-belt 30 shortens by a substantially equal amount.

In this embodiment, the spool circumference should be greater than the sum of the maximum motion required on each axis to prevent the belt 30 overlapping on the spindles 24, 28.

Likewise, if both the first spindle 24 and the second spindle 28 are rotated in an anti-clockwise direction, at the same rotational velocity, then at least a portion of the drive-belt 30 will be unwound from the second spindle 28 and a substantially equal portion, to the portion unwound from the second spindle 28, of the drive-belt 30 is wound onto the first spindle 24 (at substantially the same rate). The printhead 12 moves in the third direction, e.g., substantially horizontally left, (still along axis B) because the plate 46 to which the printhead is indirectly attached is caused to move along the second track portion 54 in the third direction. In other words, when both spindles 24, 28 rotate in the same direction, at substantially the same rotational velocity, the printhead 12 moves in either a third or fourth direction. In this example, the first portion 30a of the drive-belt 30 shortens and the second portion 30b of the drive-belt extends by a substantially equal amount.

If the first motor 22, or the first and second motors 22, 26 rotate the first and second spindles 24, 28 in opposite directions, the length of drive-belt 30 in the belt path between the first and second spindles 24, 28 varies (i.e. the length of drive-belt 30 between the corresponding positions on the first and second spindles 24, 28, e.g. the top dead centre positions, varies). This causes the printhead 12 to move along the first track portion 48. For example, in an embodiment with two motors 22, 26, if the first motor 22 rotates in an anti-clockwise direction and the second motor 26 rotates in a clockwise direction, at least a portion of the drive-belt 30 is wound onto each of the first and second spindles 24, 28. This results in a reduction in the length of drive-belt 30 in the belt path between the first and second spindles 24, 28. As the at least a portion of the drive-belt 30 is wound onto the spindles 24, 28, a force is exerted on the connection part 16 in the second, e.g. downward, direction. This causes the connection part 16 and the printhead 12 to move in the second (e.g. downward) direction along the first track portion 48 (along axis A).

If the first motor 22 rotates in a clockwise direction and the second motor 26 rotates in an anti-clockwise direction, at least a portion of the drive-belt 30 is unwound from both the first and second spindles 24, 28. The length of drive-belt 30 in the belt path increases between corresponding positions on the perimeters of the spindles, e.g. the top dead centre positions of the first and second spindles 24, 28. In this embodiment, as the length of drive-belt 30 in the belt path increases, the force exerted on the connection part 16 is reduced. The biasing members 52a, 52b shorten and act to pull the printhead 12 in the first (e.g. upward) direction relative to the first track assembly 42 (i.e. an upwards biasing force is applied to the printhead 12).

It should also be appreciated that the printhead 12 is not limited to movement along one axis A, B at a time (i.e. movement of the printhead 12 is not limited to one of the first to fourth directions at one time). The control assembly 10 is operable to rotate the first and second spindles 24, 28 at different rotational velocities, which allows the printhead 12 to move both substantially horizontally and substantially vertically at the same time.

For example, if the printhead 12 is required to move upwards and right then (in the illustrated embodiment of FIG. 1) both the spindles 24, 28 are rotated clockwise and the second spindle 28 is driven at a slower rotational velocity than the first spindle 24. The printhead 12 is pulled right by the movement of the second spindle 28 as at least a portion of the drive-belt 30 is wound onto the second spindle 28 and the printhead 12 is pulled upwards by the biasing members 52a, 52b because the first spindle 24 is rotating faster, and hence unwinding more drive-belt 30 into the belt path, than is wound onto the second spindle 28. It should be appreciated that moving the printhead 12 along two axes A, B substantially simultaneously is controlled by driving the spindles 24, 28 at different relative rotational velocities.

The control assembly 10 is able to calculate the respective rotational velocities required by the or each motor 22, 26 to move the printhead 12 to any desired position relative to the backing plate 14 and/or the spindles 24, 28 and/or the substrate/platen/roller.

In other words, a part of the printhead movement assembly 40 is connected to the drive-belt assembly 20. Operation of the or each motor 22, 26 causes the printhead 12 to move relative to a part of the first movement assembly 42, along the first axis A. Operation of the or each motor 22, 26 is also configured to cause the printhead 12 to move relative to part of the second movement assembly 44, along the second axis B. It should be appreciated that movement of the printhead 12 along both axes is not necessarily simultaneous, but the or each motor 22, 26 must be operable to move the printhead 12 along both axes.

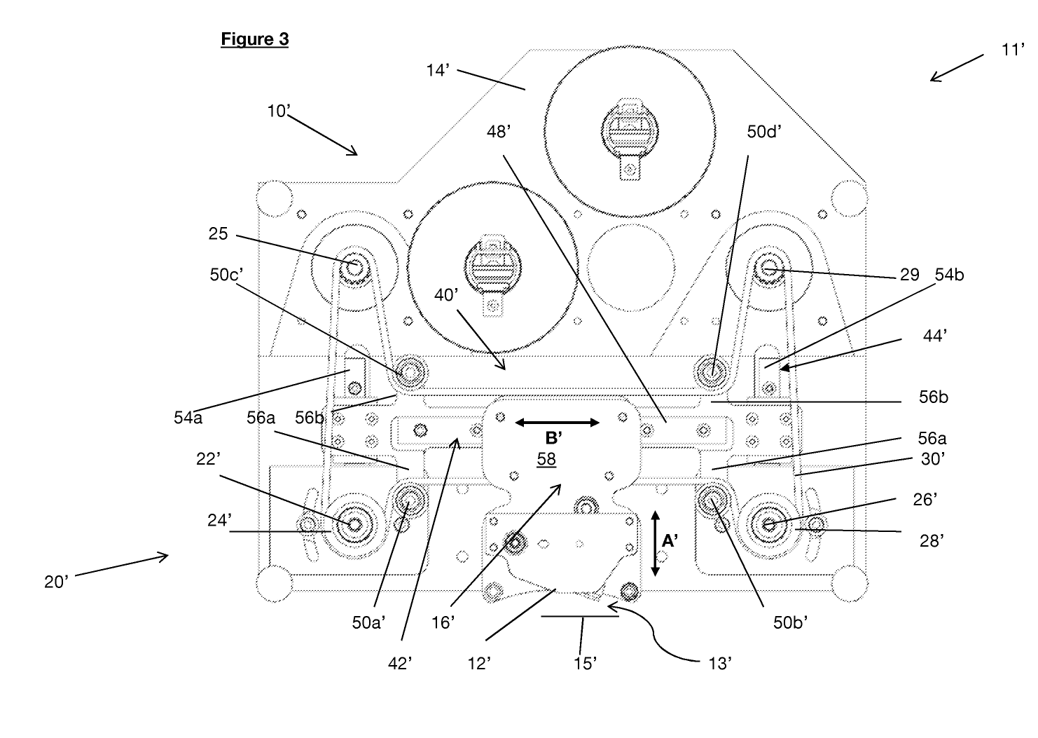

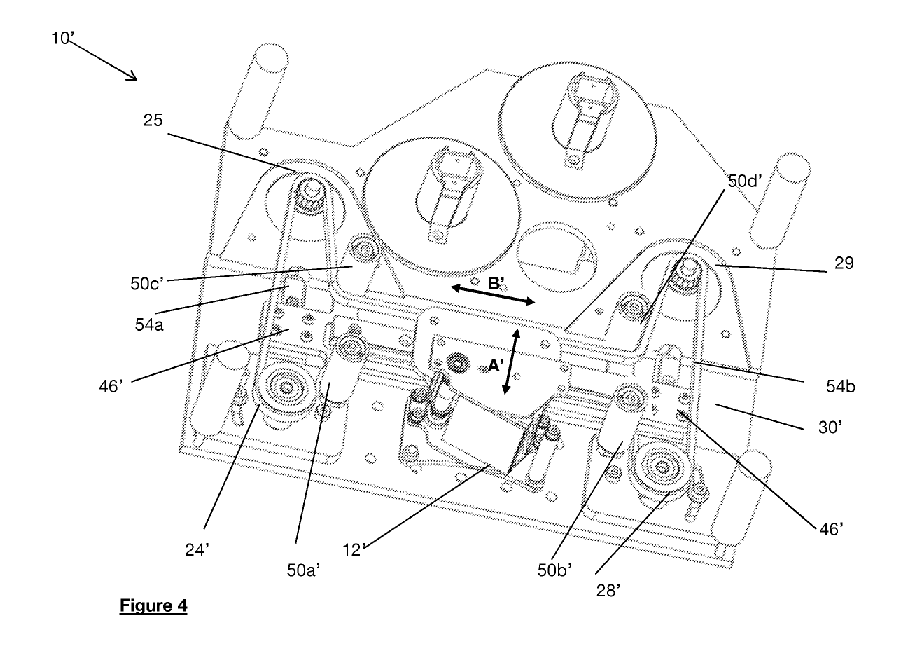

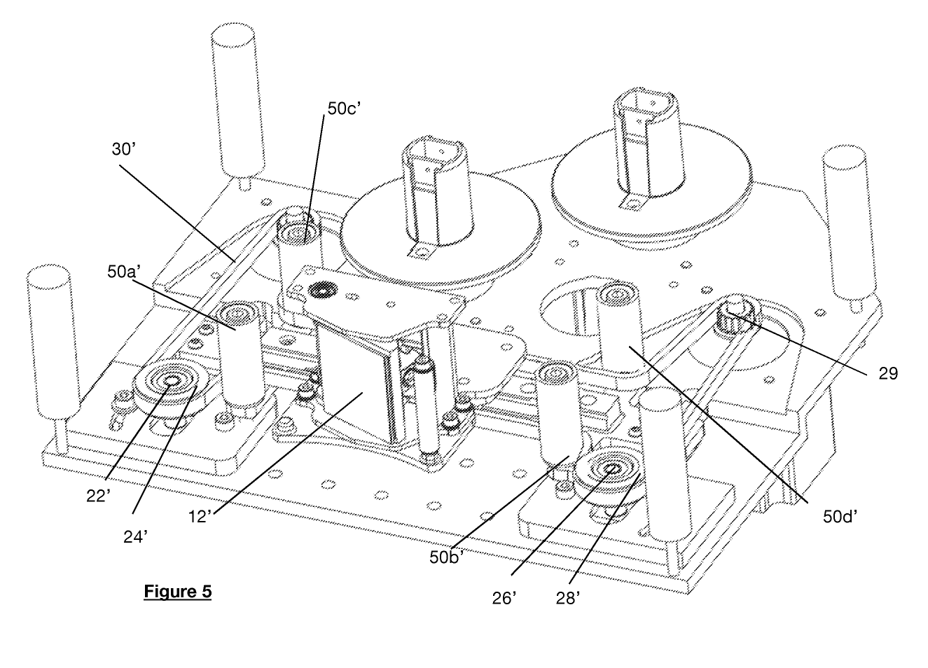

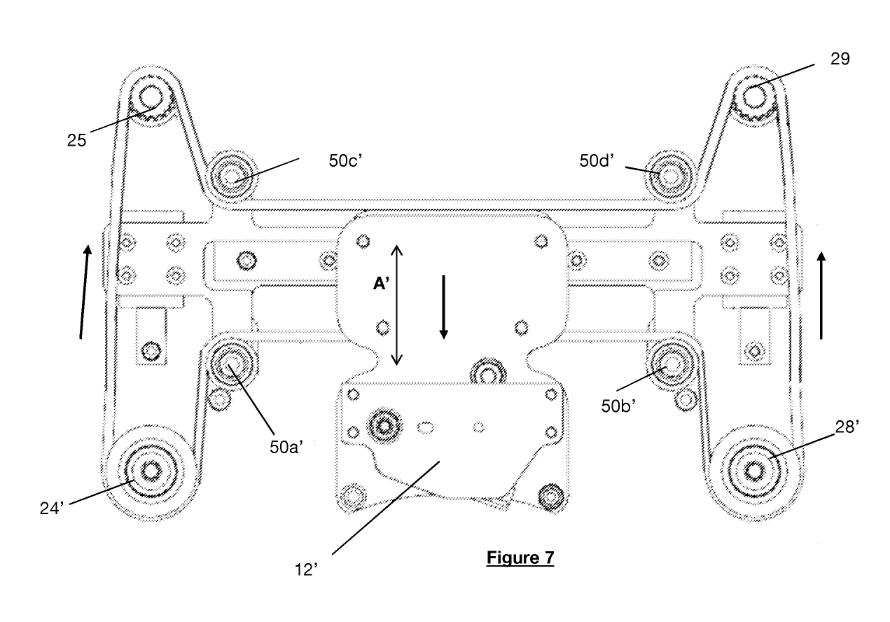

A second embodiment of the invention will now be described with reference to FIGS. 3 to 7. The features of the second embodiment which are the same/perform the same function as those features already described will have the same reference with a prime (e.g. reference 10 will become 10′). Unless explicitly stated otherwise, any of the features of the embodiment described below can be combined with any of the features of the embodiment already described.

The control assembly 10′ includes a drive-belt assembly 20′ and a printhead movement assembly 40′. Similarly to above, the drive-belt assembly 20′ is engageable with and/or connectable to the printhead movement assembly 40′, so that the control assembly 10′ is operable to control movement of a printhead 12′. As before, the printhead 12′ includes heating elements 13′, which are heated to a desired temperature to melt the ink from the ribbon onto a substrate 15′, so a desired image/text can be printed. Further, components of the control assembly 10′ are mounted on a backing plate 14′, which is integrated into a printing apparatus 11′. The printing apparatus 11′ is generally operated in the same way as the printing apparatus 11 described above.

The printhead movement assembly 40′ includes a first movement assembly 42′ and a second movement assembly 44′. The first movement assembly 42′ enables the printhead 12′ move in first and second directions, along a first axis B′ (in this embodiment, the first axis B′ extends substantially horizontally).

The first movement assembly 42′ includes a plate 46′, a first track portion 48′, and four belt guides 50a′, 50b′, 50c′, 50d′ (i.e. first to fourth belt guides). The plate 46′ is substantially planar and is generally elongate. It will be appreciated that the plate 46′ may be of any appropriate shape and configuration. In the present example a pair of arms 56a, 56b extends outwardly substantially perpendicularly (e.g. within +/−1 to 2 degrees) from the plate 46′ (in the same plane as the rest of the plate 46′) at each end of the plate 46′.

The first track portion 48′ is positioned in a substantially horizontal orientation (when the control assembly 10′ is in “normal” orientation) and is attached to the plate 46′. The first track portion 48′ supports the printhead 12′ and permits the printhead 12′ to move substantially reciprocally, horizontally along the first axis B′, relative to the first track portion 48′ (e.g. the printhead 12′ moves along the first track portion 48′ in first, e.g. substantially left, and second, e.g. substantially right, directions).

The printhead 12′ includes a connection part 16′ which is connected to and/or engageable with the drive-belt 30′. In this example, the connection part 16′ is part of a support plate 58 on which the printhead 12′ is mounted. However, the drive-belt 30′ can be attached directly to and/or engageable with the printhead 12′ or alternatively another part of the printhead movement assembly 40′.

The plate 46′ is mounted on or engageable with the second movement assembly 44′ such that the first movement assembly 42′, and therefore the printhead 12′, are moveable by operation of the second movement assembly 44′. The second movement assembly 44′ supports the first movement assembly 42′ and permits the first movement assembly 42′, and therefore the printhead 12′, to move along a second axis A′ (in this embodiment, the second axis A′ extends substantially vertically).

The second movement assembly 44′ has a pair of second track portions 54a, 54b which are attached to the backing plate. Although two track portions 54a, 54b are used in this embodiment to give greater mechanical stability to the movement assembly 42′ it should be appreciated that the number of tracks can be altered depending on the size of the mechanism required. The second track portions 54a, 54b extend substantially parallel (e.g. within +/−1 to 2 degrees) to one another, so as to allow movement of the first movement assembly 42′ along the second axis A′ (in this example, the first movement assembly 42′ allows substantially reciprocating movement in a substantially vertical (i.e. first and second) direction when the control assembly 10′ is in “normal” orientation). Each end of the first movement assembly 42′ is mounted to a respective second track portion 54a, 54b and as such the printhead 12′ (which is supported by the first movement assembly 42′) is moveable in a substantially vertical direction relative to the second movement assembly 44′.

In the present example, each end of the plate 46′ is connected to or engageable with a respective second track portion 54a, 54b, although it will be appreciated that another part of the first movement assembly 42′ may be mounted to the second track portion 54a, 54b, either directly or indirectly.

In some embodiments, the drive-belt assembly 20′ has a first motor 22′ which is operable to rotate a first spindle 24′. In some embodiments, the drive-belt assembly 20′ may also have a second motor 26′ which is operable to rotate a second spindle 28′. Both spindles typically have the same diameter. The first and second motors 22′, 26′ are mounted on the backing plate 14′. The first and second spindles 24′, 28′ are spaced apart generally horizontally (when the control assembly 10′ is in “normal” operating orientation). The first and second spindles 24′, 28′ are also positioned at generally the same height on the backing plate 14′.

The drive-belt assembly 20′ further includes third and fourth spindles 25, 29. The third spindle 25 is spaced apart substantially vertically from the first spindle 24′, and the fourth spindle 29 is spaced apart substantially vertically from the second spindle 28′. In other words, each of the spindles 24′, 28′, 25, 29 is positioned at a corner of a square or rectangle shape. However, it should be appreciated that the spindles 24′, 28′, 25, 29 do not have to form a square or rectangle.

In this embodiment, the first and second motors 22′, 26′ are operable to drive the first and second spindles 24′, 28′, respectively. It should be appreciated that the first and second motors 22′, 26′ can be operable to drive the third and fourth spindles 25, 29 and/or extra motors can be provided. For example, four motors can be provided, such that each spindle 24′, 28′, 25, 29 is driven by a respective motor.

In some embodiments, particularly those in which one motor is used, the drive-belt assembly 20′ may also include one or more of a clutch mechanism, a gearing mechanism or other operating mechanism which allows independent control of the spindles 24′, 28′, 25, 29 (e.g. at different rotational speeds and/or different directions and/or the same rotational speeds and/or the same direction).

Four belt guides 50a′, 50b′, 50c′, 50d′ (in this example, four substantially cylindrical rollers) are mounted on the plate 46′. Each belt guide 50a′, 50b′, 50c′, 50d′ is connected to a part of the first movement assembly 42′. In the present example, each belt guide 50a′; 50b′; 50c′; 50d′ is positioned on one of the arms 56a, 56b (i.e. one belt guide 50a′, 50b′, 50c′, 50d′ per arm). The belt guides 50a′, 50b′, 50c′, 50d′ further define the belt path and the drive-belt 30′ is disposed around each of the belt guides 50a′, 50b′, 50c′, 50d′.

In this example, the belt guides 50a′, 50b′, 50c′, 50d′ are positioned within the area defined by the spindles 24′, 28′, 25, 29. In other words, the belt guides 50a′, 50b′, 50c′, 50d′ are located within the square/rectangle which is defined by the spindles 24′, 28′, 25, 29. The drive-belt 30′ extends around each of the spindles 24′, 28′, 25, 29 and the belt guides 50a′, 50b′, 50c′, 50d′ and is connected/connectable to and/or engageable with the printhead 12′, and forms a “H”-shape (in side view). However, it should be appreciated that this need not necessarily be the case.

Each belt guide 50a′, 50b′, 50c′, 50d′ is considered to be paired with a respective spindle 24′, 28′, 25, 29. For example, the first belt guide 50a′ is considered to be paired with the first spindle 24′ (and the second belt guide 50b′ is paired with the second spindle 28′, and so on for the other two pairs).

It is advantageous if each “pair” of a belt guide 50a′-d′ and a spindle 24′, 28′, 25, 29 is positioned such that parts of a belt path (the “path” through which a drive-belt 30′ extends) at either side of the belt guide 50a′, 50b′, 50c′, 50d′ are substantially perpendicular with one another. In other words (taking the first belt guide 50a′ and the first spindle 24′ as an example), the first spindle 24′ is positioned so that the drive-belt 30′ extends generally vertically towards the belt guide 50a′. The drive-belt 30′ extends around the belt guide 50a′ and continues, generally horizontally, towards the connection part 16 of the printhead 12. Hence, the belt path (and the drive-belt 30′) extends in a generally transverse direction on either ‘side’ of the belt guide 50a′. Thus, the “pairs” of belt guides 50a′, 50b′, 50c′, 50d′ and spindles 24′, 28′, 25, 29 can be positioned in many locations while maintaining an advantageous relationship between the “pairs” (i.e. to allow a general right angle around the respective belt guide 50a′, 50b′, 50c′, 50d′). It will be appreciated that this arrangement is not essential and knowledge of the relative positions of the belt guides 50a′-50d′ and the respective spindles allows the control assembly to determine how the or each of the motors 22′, 26′ should be driven to achieve the desired movement of the printhead.

The spindles 24′, 28′, 25, 29 and the belt guides 50a′, 50b′, 50c′, 50d′ define the entire belt path (in this case, a generally rectangular belt path around each of the spindles 24′, 28′, 25, 29, with belt guides positioned within—however, as described above this is not essential). The drive-belt 30′ forms a continuous loop around the spindles 24′, 28′, 25, 29. The drive-belt 30′ follows the belt path and is in driving engagement with and extends between the first and second spindles 24′, 28′ (although it should be appreciated that the drive-belt 30′ may also be in driving engagement with the third and fourth spindles 25, 29 or all of the spindles 24′, 28′, 25, 29).

The belt path includes portions of drive-belt 30′ which can be considered to be paired with one another. For example, a first portion 30a′ of drive-belt 30′ which extends between the spindle 24′ and the belt guide 50a′ is paired with a second portion 30b′ of drive-belt 30′ which extends between the spindle 25 and the belt guide 50c′. A third portion 30c of the drive-belt 30′ extending between the spindle 28′ and the belt guide 50b′ is paired with a fourth portion 30d of the drive-belt 30′ which extends between the spindle 29 and the belt guide 50d′. A fifth portion 30e of the drive-belt 30′ which extends between the belt guide 50a′ and the printhead 12′ is paired with a sixth portion 30f of the drive-belt 30′ which extends between the belt guide 50b′ and the printhead 12′.

In use, the control assembly 10′ controls the movement of the printhead 12′ both in a substantially horizontal direction and in a substantially vertical direction. The control assembly 10′ is able to move the printhead 12′ in a single direction at a time, by operating one movement assembly 42′, 44′ at a time, or along both track portions 48′, 54a, 54b substantially simultaneously, in a ‘combined movement’.

The first motor 22′, or the first and second motors 22′, 26′ are operable to cause movement of the drive-belt 30′. The drive-belt 30′ is connected to or engageable with the printhead 12′ (via the connection part 16′), and hence when the drive-belt 30′ moves, the printhead 12′ also moves. The printhead 12′ is moveable relative to at least one of the track portions 48′, 54a, 54b first and/or second movement assemblies 42′, 44′, along the first and/or second axes B′, A′.

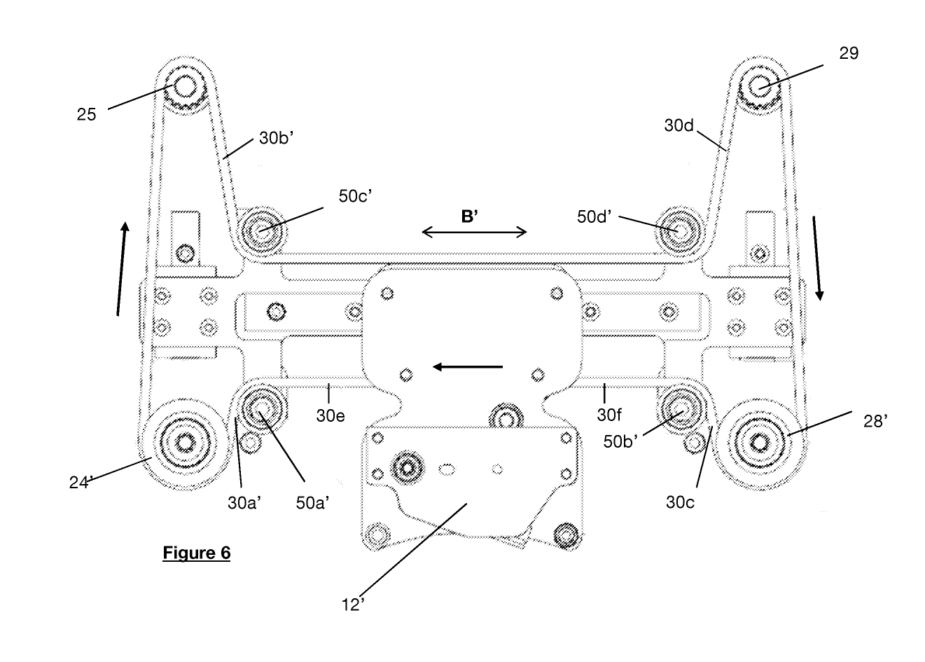

For example, in some embodiments, when the first and second motors 22′, 26′ are driven in the same rotational direction, at substantially the same rotational speed (e.g. as defined by the tolerances of the motor(s) and mechanical structures used), and assuming that the spindles 24′ and 28′ are substantially the same diameter, the drive-belt 30′ is fed around the spindles 24′, 28′, 25, 29 (i.e. around at least a part of the belt path) and the printhead 12′ is moved substantially left or right (depending on the direction of rotation), along the first axis B′. For example, when both the first motor 22′ and the second motor 26′ rotate in a clockwise direction (at substantially the same rotational velocity), then the drive-belt 30′ will be fed around the spindles 24′, 28′, 25, 29 and belt guides 50a′, 50b′, 50c′, 50d′ in a clockwise direction. Hence, the printhead 12′ moves substantially horizontally left (i.e. in the first direction) relative to the first track portion 48′. The arrows in FIG. 6 illustrate the direction of the drive-belt 30′ and the printhead 12′, in the above example. In this example, the fifth portion 30e of drive-belt 30′ shortens, and the sixth portion 30f of drive belt 30′ lengthens by a substantially equal amount.

When the first and second motors 22′, 26′ are rotated anti-clockwise at substantially the same rotational velocity, the drive-belt 30′ is fed anti-clockwise around the belt path. Hence, the printhead 12′ moves substantially horizontally right (i.e. in the second direction) along the first track portion 48′. It should be appreciated that the arrows in FIG. 6 should be reversed to illustrate this movement. In this example, the sixth portion 30f of the drive-belt 30′ shortens and the fifth portion 30e of the drive-belt 30′ lengthens by substantially the same amount.

When the first and second motors 22′, 26′ are rotated in opposite directions, the length of the belt path between the first and second spindles 24′, 28′ (i.e. the length of the drive-belt 30′ portion between a bottom dead centre position of the first spindle 24′ and a respective bottom dead centre of the second spindle 28′) varies. Reference to the bottom dead centre position means a point on a perimeter of the respective spindle 24′, 28′ which is intersected by a vertical line passing through the central point of the spindle 24′, 28′ and through a lowermost point on the perimeter of the spindle 24′, 28′. This causes at least a part of the first track assembly 42′ (and hence the printhead 12′) to move along the second track portions 54a, 54b. For example, when the first motor 22′ rotates anti-clockwise and the second motor 26′ rotates clockwise, the length of the drive-belt 30 between the first spindle 24′ and the second spindle 28′ extends (and the length of the drive-belt 30′ between the third and fourth spindles 25, 29 reduces). Therefore, the drive-belt 30′ pulls the third and fourth belt guides 50c′, 50d′ upwards.

In other words, the length of the drive-belt 30′ between the first spindle 24′ and the first belt guide 50a′ extends. Likewise, the length of the drive-belt 30′ between the second spindle 28′ and the second belt guide 50b′ also extends. The length of drive-belt 30′ between the third spindle 25 and the third belt guide 50c′ reduces as does the length of the drive-belt 30′ between the fourth spindle 29 and the fourth belt guide 50d′ . Therefore, the printhead 12′ moves in the first (e.g. upward) direction, along the second axis A′.

In this example, the first and third portions 30a′, 30c of the drive-belt 30′ lengthen and the second and fourth portions 30b′, 30d, of the drive-belt 30′ shorten by a substantially equal amount. Thus it will be seen that the pairs of portions 30a′, 30b′; 30c, 30d, of the drive-belt 30′ of the second embodiment mirror one another's movement. This is as a result of the belt guides 50a′, 50b′, 50c′, 50d′ being attached to the plate 46′, which is substantially rigid, and so as the belt guides 50c′, 50d′ move upwards, reducing the distance between the belt guides 50c′, 50d′ and the respective spindles 25, 29, so must the belt guides 50a′ 50b′, which increases the distance between the belt guides 50a′, 50b′ and the respective spindles 24′, 28′.

When the first motor 22′ rotates clockwise and the second motor 26′ rotates anti-clockwise, the drive-belt 30′ pulls the first and second belt guides 50a′, 50b′ downwards. The length of the drive-belt 30′ between the first and second spindle 24′, 28′ reduces (and the length of the drive-belt 30′ between the third and fourth spindles 25, 29 increases). In other words, the length of the drive-belt 30′ between the first spindle 24′ and the first belt guide 50a′ is reduced. Likewise, the length of drive-belt 30′ between the second spindle 28′ and the second belt guide 50b′ is also reduced. Hence, the first movement assembly 42′ (and the printhead 12′) moves in the second (e.g. downward) direction.

In each type of movement of the printhead 12′, a substantially equal and opposite change in length occurs to each portion 30a′, 30b′, 30c, 30d, 30e, 30f of at least one pair of portions of drive-belt 30′.

As described above, in relation to the first embodiment, the control assembly 10′ is also able to move the printhead 12′ in two directions at the same time by driving the motors 22′, 26′ at different rotational velocities.

For example, in order to drive the printhead 12′ right and down, both motors 22′, 26′ are driven anti-clockwise, and the second motor 26′ is driven faster than the first motor 22′.

More generally (as discussed above, operation of the or each motor 22′, 26′ causes the printhead 12′ to move relative to a part of the first movement assembly 42′ along the second axis A′ and operation of the or each motor 22′, 26′ is also configured to cause the printhead 12′ to move relative to a part of the second movement assembly 44′ along the first axis B′. The movement along both axes A′, B′ may not be simultaneous, but the control assembly 10′ must be operable to move the printhead 12′ along both axes A′, B′.

In the depicted embodiments the first and second axes A and B, A′ and B′ are substantially orthogonal to one another (e.g. within 1, 2, 3, 4, or 5 degrees of being exactly perpendicular to each other). It should be appreciated that this need not necessarily be the case.

It should be appreciated that there may be more than one sequence of actions that can result in moving the printhead 12,12′ to a desired location. For example, consider the situation that the printhead 12,12′ is required to move from point X to point Y, where point Y is diagonally up and right from point X. There are at least three alternative sequences or combinations of movements that result in the printhead 12, 12′ moving to point Y from point X. Firstly, both the first and second spindles 24, 24′, 28, 28′ may rotate in the same direction and at substantially the same velocities to move the printhead 12, 12′ horizontally and, subsequently, one of the spindles 24, 24′, 28, 28′ may reverse rotation direction to move the printhead 12, 12′ vertically to arrive at point Y. Secondly, the two movement “actions” may be reversed, e.g. the vertical movement may be followed by a horizontal movement and the printhead 12, 12′ will still arrive at point Y. Thirdly, the first and second spindles 24, 24′, 28, 28′ may be rotated at different velocities to move the printhead 12, 12′ in both the horizontal direction and the vertical direction simultaneously. Each sequence or simultaneous combination of movements may be considered to be a single “movement phase”. Generally, the different methods of operation described above (and those claimed), should be considered to be combinable in sequence to achieve the required movement of the printhead 12, 12′. In other words, none of the methods of operating the control assembly 10, 10′ exclude any other methods of operation.

The motors 22, 22′, 26, 26′ used in the embodiments described above are hybrid stepper motors. However, it should be appreciated that any position controlled motor may be used.

An advantage of embodiments of the invention is that the control assembly 10, 10′ is configured to move the printhead 12, 12′ along two axes A, B, A′, B′ (each axis allowing movement in two opposing directions, so two axes allows four directions of movement) with one system. Therefore, the system is simplified and easier to manufacture.

Additionally, one complete system (i.e. the control assembly 10, 10′) is easier to install in a printing apparatus 11, 11′ because there is no need to ensure one part of the system (i.e. a part for moving the printhead 12, 12′ up and down) is positioned in a correct position relative to another part of the system (i.e. a part of the system for moving the printhead 12, 12′ left and right).

A further advantage of embodiments of the invention is that the motors 22, 22′, 26, 26′ are not moved by either of the first or the second movement assemblies 42, 42′, 44, 44′. This means that the mass of the moving parts is reduced, and as such the control assembly 10, 10′ has lower power consumption.

A further advantage of embodiments of the invention is that using the control assembly 10, 10′ to control the movement of the printhead 12, 12′ during operation of a printing apparatus 11, 11′ is simplified with the use of only one or two motors 22, 26 and a pair of biasing members 52a, 52b.

Another advantage of embodiments of the invention is that the printhead 12, 12′ can be actively driven in four directions. This results in lower power consumption because the control assembly 10, 10′ does not waste power driving the printhead 12, 12′ against any biasing members.

An advantage of the second embodiment is that the printhead 12′ is positively driven in all directions, and is not reliant on biasing members to ‘return’ the printhead 12′ to a bias position. The omission of biasing members reduces the likelihood of resonance in the system.

The force exerted by the printhead 12 is produced by both motors 22, 26 meaning that each motor can be half the size of the motor that would be required should the force be generated by a single motor.

For the avoidance of doubt, where portions of the drive-belt 30, 30′ are referred to as “extending” or “shortening”, this does not refer to the drive-belt material stretching or otherwise deforming.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1-3. (canceled)

4. A control assembly for moving a printhead of a printing apparatus, the control assembly comprising:
a drive-belt assembly including
a first spindle,
a second spindle, the first and second spindles defining at least a portion of a belt path,
a motor which is operable to rotate at least one of the first spindle or the second spindle, and
a drive-belt engaged with and extending between the first and second spindles, the motor being operable to cause movement of the drive-belt and
a printhead movement assembly including
a first movement assembly on which a printhead is supportable and allows movement of the printhead along a first axis, and
a second movement assembly which is configured to support the first movement assembly, the second movement assembly permitting movement of the first movement assembly and the printhead along a second axis;
wherein at least a part of the printhead movement assembly is connectable to the drive-belt of the drive-belt assembly, and when the at least a part of the printhead movement assembly is connected to the drive-belt, respective operations of the motor cause (i) a combined movement of the printhead along the first axis and the second axis simultaneously and (ii) a movement phase in which the printhead is moved along the first axis and the second axis sequentially; and
wherein the printhead movement assembly includes a biasing member, which is configured to oppose the movement of the printhead along one of the first and second axes, in at least one direction.

5. A control assembly according to claim 4, wherein the biasing member is a coil spring.

6-19. (canceled)

20. A control assembly according to claim 4, wherein the biasing member comprises one or more biasing members arranged to cause a combined force to act through a center of a track portion of the first movement assembly, the track portion defining the first axis, and wherein an operation that causes the combined movement of the printhead along the first axis and the second axis simultaneously comprises driving the first and second spindles at different relative rotational velocities.

21. A control assembly according to claim 20, wherein the one or more biasing members comprise a pair of biasing members arranged to cause the combined force of the pair of biasing members to act through the center of the track portion of the first movement assembly.

22. A control assembly according to claim 21, wherein a first end portion of the drive-belt is connected to the first spindle, and a second end portion of the drive-belt is connected to the second spindle.

23. A control assembly according to claim 22, wherein a spool circumference of each of the first and second spindles is greater than a sum of a maximum motion required on each of the first and second axes to prevent the drive-belt overlapping itself on either of the first and second spindles.

24. A control assembly according to claim 23, wherein the drive-belt includes at least two portions which are paired with one another, wherein an operation of the movement phase causes movement of the printhead along the second axis by extending one of the paired portions of the drive-belt and shortening the other paired portion of the drive-belt by a substantially equal amount, and wherein the printing apparatus is of a type which uses the printhead to transfer ink from a ribbon on to a substrate.

25. A control assembly according to claim 24, wherein the motor is a first motor, and the drive belt assembly includes a second motor which is operable to rotate the other of the first and second spindles.

26. A control assembly according to claim 25, wherein the first and second axes are substantially orthogonal to one another.

27. A control assembly according to claim 26, wherein the pair of biasing members are biased to oppose downward movement of the printhead relative to the track portion.

28. A method comprising:
bringing a printhead of a printing apparatus into proximity with a substrate on which printing will occur, wherein the printing apparatus includes a control assembly comprising a drive-belt assembly and a printhead movement assembly,
the drive-belt assembly including
a first spindle,
a second spindle, the first and second spindles defining at least a portion of a belt path,
a motor which is operable to rotate at least one of the first spindle or the second spindle, and
a drive-belt engaged with and extending between the first and second spindles, the motor being operable to cause movement of the drive-belt, and
the printhead movement assembly including
a first movement assembly on which the printhead is supportable and allows movement of the printhead along a first axis,
a second movement assembly which is configured to support the first movement assembly, the second movement assembly permitting movement of the first movement assembly and the printhead along a second axis, and
at least a part of the printhead movement assembly is connected to the drive-belt of the drive-belt assembly; and
causing a combined movement of the printhead along the first axis and the second axis simultaneously by operating the motor to rotate the first spindle and the second spindle by different amounts; and
causing a movement phase in which the printhead is moved along the first axis and the second axis sequentially by operating the motor to rotate the first spindle and the second spindle by a first same amount for movement along the first axis and by operating the motor to rotate the first spindle and the second spindle by a second same amount for movement along the second axis.

29. A method according to claim 28, wherein the biasing member comprises one or more biasing members arranged to cause a combined force to act through a center of a track portion of the first movement assembly, the track portion defining the first axis, and wherein causing the combined movement of the printhead along the first axis and the second axis simultaneously comprises driving the first and second spindles at different relative rotational velocities.

30. A method according to claim 29, wherein the one or more biasing members comprise a pair of biasing members arranged to cause the combined force of the pair of biasing members to act through the center of the track portion of the first movement assembly, and wherein causing movement of the printhead along the first axis comprises:
causing the pair of biasing members to shorten when moving the printhead in a first direction along the first axis; and
causing the pair of biasing members to lengthen when moving the printhead in a second direction along the first axis.

31. A method according to claim 30, wherein the pair of biasing members comprise a pair of coil springs, and wherein causing movement of the printhead along the first axis comprises:
causing the pair of coil springs to shorten when moving the printhead in the first direction along the first axis; and
causing the pair of coil springs to lengthen when moving the printhead in the second direction along the first axis.

32. A method according to claim 30, wherein a first end portion of the drive-belt is connected to the first spindle, and a second end portion of the drive-belt is connected to the second spindle, and wherein operating the motor comprises:
operating the motor to move the drive-belt through the first end portion by rotating the first spindle; and
operating the motor to move the drive-belt through the second end portion by rotating the second spindle.

33. A method according to claim 32, wherein a spool circumference of each of the first and second spindles is greater than a sum of a maximum motion required on each of the first and second axes, and wherein causing the combined movement and causing the movement phase comprises using the spool circumference of each of the first and second spindles to prevent the drive-belt overlapping itself on either of the first and second spindles.

34. A method according to claim 33, wherein the drive-belt includes at least two portions which are paired with one another, wherein causing the movement phase comprises causing movement of the printhead along the second axis by extending one of the paired portions of the drive-belt and shortening the other paired portion of the drive-belt by a substantially equal amount, and wherein the method comprises transferring ink from a ribbon to the substrate using the printhead.

35. A method according to claim 34, wherein the motor is a first motor, and the drive belt assembly includes a second motor, and wherein causing the combined movement and causing the movement phase comprises rotating the first spindle using the first motor and rotating the second spindle using the second motor.

36. A method according to claim 35, wherein the first and second axes are substantially orthogonal to one another, and wherein causing the combined movement and causing the movement phase comprises moving the printhead along the substantially orthogonal first and second axes.

37. A method according to claim 36, wherein the pair of biasing members are biased to oppose downward movement of the printhead relative to the track portion, and wherein causing the pair of coil springs to shorten comprises moving the printhead upward along the first axis, and causing the pair of coil springs to lengthen comprises moving the printhead in downward along the first axis.
